(19) United States
(12) Patent Application Publication
(10) Pub. No.: US 2006/0259306 A1
(43) Pub. Date: Nov. 16, 2006

(54) Business method protecting jokes

(76) Inventor: Timothy Wace Roberts, Bracknell (GB)

Correspondence Address: T.W. Roberts, 13 Spring Meadow, Brackell, DE

(21) Appl. No.: 10/569,506

(22) PCT Filed: Aug. 24, 2004
(86) PCT No.: PCT/IB04/02736

§ 371 Date: Feb. 27, 2006

(30) Foreign Application Priority Data
Aug. 30, 2003 (GB) 0320419.5

(51) Int. Cl. G06Q 99/00

(52) U.S. Cl. 705/1

(57) ABSTRACT

The specification describes a method of protecting jokes by filing patent applications therefor, and gives examples of novel jokes to be thus protected. Specific jokes to be protected by the process of the invention include stories about animals playing ball-games, in which alliteration is used in the punch-line; a scheme for raising money for charity by providing dogs for carriage by Underground passengers; and the joke that consists in filing a patent application to protect jokes. A novel type of patent application, one that claims itself, and hence is termed ‘homoproprietary’, is disclosed.

The present invention relates to a novel business method. More particularly, it relates to a method of protecting novel jokes, and to jokes that may be so protected.

Knowledge is a free good. However, producing new knowledge usually costs money. Increasingly it is recognised that investment in producing new knowledge needs to be encouraged by protection for the results of that investment. The protection available for these results has expanded over time. For example, under the old UK patent law before 1978, protection was only available for a ‘manner of manufacture’. This requirement was construed broadly, for example to include methods of dispersing fog. In 1978, the UK adopted the new European code, which provided protection for ‘inventions susceptible of industrial application’. The new European law specifically excludes various things, including:

“discoveries; aesthetic creations; . . . schemes, rules and methods for performing mental acts, playing games or doing business, and programs for computers; presentations of information”. Also excepted are surgery, therapy and diagnostic methods practised on the human or animal body; as well as plant and animal varieties.

However, over the years European jurisprudence has narrowed several of these exceptions. Thus, for example, though discoveries per se remain unpatentable, newly isolated gene sequences can be patented, though many regard them as no more than discoveries; programs for computers can be patented if they give rise to a ‘technical effect’; plant varieties can be protected by patent where the invention claimed is broader than a single specific variety; and novel uses of known pharmaceuticals can be protected by means of ‘Swiss-type’ claims (preparation of a compound “for use in the manufacture of a treatment for disease X”).

At present, practice in the European patent office does not permit the patenting of ‘business methods’ (at least, where no ‘technical effect’ can be demonstrated). However, as previously noted, practice does not stand still. Increasingly, globalisation leads to pressure for conformity in world practice, so innovations in one country may rapidly be taken up by others.

It is thus significant that the USA has recently clarified its law on the patenting of ‘business methods’. The State Street Bank case (State Street Bank & Trust Co.

v. Signature Financial Group Inc., CAFC, 23 Jul. 1998) clarified that, contrary to what had often been thought, there was no per se rule against patenting business methods. This ruling has given rise to a wave of ‘business method’ patents, including for example the well-known ‘one-click’ patent of Amazon, U.S. Pat. No. 5,960,411, on a method of placing purchase orders on a communications network (such as the Internet);

Most forms of medicine can be protected by patent applications in most countries. In the European Patent Office, for example, a new chemical compound useful as a pharmaceutical can be protected per se. Old chemical compounds can be protected for use as medicines. Where a known drug (D) is found to be effective against a new ailment(A), this discovery can be protected, by means of a ‘Swiss-type claim’—“Use of drug D in the manufacture of a medicament for the treatment of ailment A”.

As the old saying goes: “Laughter is the best medicine”. Protection should be available for this medicine also. Nor is the utility of jokes confined to the medicinal field: a number of other utilities are noted below. There is a clear need here for intellectual property protection, so as to reward those who devise effective novel jokes, and encourage the investment of time, effort and money in this pursuit.

The present invention proposes a way of procuring protection for a new joke, which comprises filing a patent application therefor defining the novel features thereof. According to a further feature of the invention, the patent application and any resulting patent is maintained (e.g., by refraining from all acts that would result in its abandonment, by requesting publication, by prosecution, preferably to grant, by defending oppositions, by paying maintenance and renewal fees, and so on. It is preferred to mark the joke with the patent application number, when the joke is published in fixed form. In further aspects the invention comprises a method of licensing protected jokes, which comprises filing a patent application for a new joke, and offering licenses for use of the joke.

In a second aspect, the invention comprises novel jokes for protection by the process of the invention.

The present invention provides an answer to a long-felt need, namely that of obtaining proper protection for jokes. It is known from the prior art to file patent applications which are funny, intentionally or otherwise (it is not always easy to tell which). Examples of such applications are, in the UK, those of Arthur Pedrick (including GB 1047735, relating to a method of irrigating arid regions by supplying them by pipeline with snowballs from the Poles, and GB 1426698 entitled “Photon Push-Pull Radiation Detector For Use In Chromatically Selective Cat Flap Control And 1000 Megaton Earth-Orbital Peace-Keeping Bomb”: in the USA, U.S. Pat. No. 5,616,089 issued Apr. 1, 1997, to a method of gripping a golf putter; U.S. Pat. No. 6,368,227 for a method of swinging on a child's swing.

However, previously patent applications have not been filed to protect jokes as such. This clearly shows the existence of a prejudice, which the present invention overcomes. The prejudice has taken several forms. It has been thought that a joke is not suitable subject-matter for a patent, for example because it is not ‘technical’. More specifically, it has been urged that a joke is an ‘aesthetic creation’. However, many things that are patented are ‘aesthetic creations’ at least in some form. Any well-designed utilitarian object is an ‘aesthetic creation’, and may be protected, in that aspect, by copyright or design right (registered or unregistered). This is no bar to protecting it by patent, if it is also new and inventive. Thus, the fact that a joke is, in its finished form, an aesthetic creation need not be an absolute bar to protecting its novel principle by patent, The situation is analogous to the European patent law on plant varieties, which refuses protection for specific varieties per se, but allows patents covering classes of varieties (EPO Enlarged Board, case G2/95). Jokes can of course be protected by copyright, but copyright only protects the form in which the joke is expressed. Patent protection will offer protection for the essential features of the joke—its underlying structure.

The present invention has more than one aspect. It includes: the process of protecting new jokes by filing patent applications thereon; and the novel jokes disclosed in the examples. More specifically it includes the particular joke which is the idea or concept of filing this particular patent application (self-reference).

An essential feature of the invention is the filing of a patent application chatacterising the novel joke, defining the novel feature, or combination of features, thereof. It is preferred to prosecute the patent application at least to publication, and if possible to grant. However, these are not essential aspects. Filing of a patent application constitutes a claim to exclusive rights, and such rights may be licensed even if not certainly valid. At the time of writing, patents for inventions relating to ‘business methods’ may be granted by the US Patent Office, the Australian Patent Office and probably by other Patent Offices, for example the Japanese Patent Office. They are typically refused by the European Patent Office. However, it is quite possible that this illiberal practice will change: as noted above, the tendency, in the European Patent Office and elsewhere, is continually to widen the categories of patentability. Thus, applications according to the invention may be filed in countries where the law is currently unfavourable: even if the law has not changed, they may benefit from the expectation that it will change, or even the possibility that it could. And in many countries the examination of patents is quite slow. A patent application may be kept pending for a number of years while all possibilities of appeal, divisional filings, continuations, etc., are exhausted. Competitors have to consider, not only what the law is, but what it might become. And potential infringers need to consider the inconvenience and expense of being sued, even if assured by credible legal advice that they will ultimately win.

Where the patent application to be filed according to the invention is a US patent application, or an application that will give rise to a US application, for example a PCT application designating USA, or a national application from which priority may be claimed, it is a preferred feature of the invention to establish conception of the joke prior to filing the US application. This may be done by writing down the joke, having it read and understood and signed, dated and witnessed as such by an independent witness. The witness should be a person having an average sense of humour, and sufficient wit to be able to understand the joke, but preferably not so much as to be likely to improve it. Improvements to the joke by the witness may give the status of co-inventor, thereby removing the witness's independent status, and hence the legal value of the witness's corroboration. Preferably the joke, having been conceived, is reduced to practice. Provided the witness to conception understands the joke, and preferably laughs, the act of witnessing the conception may constitute reduction to practice of the joke (except in the case of practical jokes, see below). If not, it may be necessary to tell the joke to an audience. However, if it is desired to protect the joke outside the USA, the audience must be under an obligation of confidence, otherwise the disclosure to the audience may deprive the joke of novelty and render it unprotectable. The invention further contemplates the exercise of diligence in reducing the joke to practice following conception, but, as noted, in most circumstances the witnessing of conception will constitute reduction to practice.

Jokes according to the invention may be recited or (in some cases) rehearsed. To recite a joke is to recount it, either orally, or in writing or other symbolic form. It may also be recited by presentation in a dramatic performance (e.g., theatre, film, television, video games). It may be rehearsed by enacting it, that is to say, by actually carrying it out. Practical jokes are intended for reproduction by rehearsal, but may also be exploited by recounting them (this will usually be more convenient, if less funny).

Jokes may be recorded in print or other permanent or semi-permanent media. It is particularly preferred according the invention to record novel jokes on computer systems (for example, the Internet) or computer-readable media (floppy discs, CDs, DVDs and the like), not only for convenience in dissemination, but also because such media may be easier to protect under European patent jurisprudence.

Royalties may be collected, from a willing licensee, from the date of publication of the patent application: and licensees may be encouraged to sign up willingly by offering differential royalty rates: for example, preferential royalties may be offered to those prepared to pay now. An added inducement would be the offer to return part of the royalties paid in the event of the patent not ultimately being granted.

All kinds of jokes may be protected by the process of the present invention. The joke may be completely new (though, as Grove J. said in the nineteenth century of mechanical inventions: “The claim may be that the whole thing is a novelty. It is difficult to suppose such patents at the present day . . . ” [Young and Neilson v. Rosenthal & Co, 1 RPC p29, at p. 33-1884]). It may be an improvement or embellishment or adaptation, e.g. updating, of a known joke type. It may take the form of an anecdote, a pun, a wisecrack, irony, a ‘shaggy dog story’, a cartoon. It may be a joke that carries an existing tendency to an absurd limit (reductio ad absurdum). Jokes may be self-referential or recursive: for example the well known: “It was a dark and stormy night: and the captain said to the mate: ‘Antonio, tell us a story!’ And thus the mate began: ‘It was a dark and stormy night.” [etc.] . . . A particularly preferred form of joke is one in which the intentions of the teller are uncertain: is the intention humorous or serious, or both? The invention envisages both verbal (including oral) jokes and visual jokes, e.g., cartoons, drawings; or they may be practical jokes. Practical jokes, for example novel forms of the traditional pail of water supported on a partly open door to drench unwary entrants, may be rehearsed (enacted physically), as well as recited. Jokes may be transposed from one culture or setting to another: for example, jokes told by the Irish about the English may be told by the English about the Irish: and such transposition may in certain circumstances be inventive.

Jokes have various functions and utilities. The main function of a joke is to amuse. However, in many situations a joke has additional utilities. Thus a joke may be told to put an audience at ease, to attract attention (as in humorous advertisements), to point a moral (didactic or campaigning jokes) or to fix a point in the audience's memory. Jokes may be used in selling or in fund-raising, e.g., for political or charitable ends.

Jokes vary in tone and subject-matter. Not all are equally acceptable, though acceptability may depend on the circumstances. Jokes about sex or bodily functions (‘dirty jokes’) are included within the scope of the invention, as are politically incorrect jokes, e.g., racist and sexist jokes. Such jokes, according to the invention, may find application as acceptable or marginally acceptable ‘black humour’ for use in certain circumstances: they may also serve a didactic function. However, it is preferred according to the invention that protected jokes should not be such as to cause significant offence to any sector of society. Where jokes are capable of causing offence, it is a preferred feature of the invention to provide a warning of their nature so that exposure to them can if desired be avoided.

The use of patent rights to protect jokes, though far from obvious, can be seen with hindsight to be a natural extension of the system for protecting inventions. Technical inventions constitute a ‘technical teaching’: humorous inventions constitute a ‘humorous teaching’. Specific applications of jokes have been discussed above. The utility of a joke depends in large manner on how funny it is: that in turn depends greatly on whether it is obvious or not. Obvious jokes are rarely funny—nor are old jokes. Patent offices are experienced in judging both novelty and obviousness, and hence well placed to pass on protection of jokes.

It is an additional feature of the invention to file patent applications protecting jokes on 1 April. In many countries, the first day of April is recognised as a day for performing practical jokes, and accordingly it may be regarded as particularly fitting to file patent applications protecting jokes on 1 April.

The following Examples illustrate the invention in several different aspects.

### EXAMPLE 1

This is an example of an adapted joke.

A known ‘shaggy dog’ story relates to a cricket-playing horse. The anecdote concerns two village cricket teams, one of whom is a player short. To make up the numbers, the visiting team asks a horse in a neighbouring field if he is willing to help them out. The horse is at first reluctant, claiming to be out of practice, but is eventually persuaded. The visiting side wins the toss and elects to bat. The horse modestly asks to be put in lower down the order, and is chosen to go in sixth wicket down, after the team's recognised batsmen. The recognised batsmen have a hard time, and, when the horse comes in, six wickets are down for 25 runs. As the horse takes guard, it is immediately apparent that he knows what he is about, and the first ball is dispatched to the boundary. From there on, the fortunes of the visiting team rapidly improve. The horse bats with style and vigour, and runs briskly between the wickets. The score mounts rapidly, and eventually the visiting side is all out for 182, the horse carrying his bat. The home side goes in. The visiting captain suggests to the horse that he should open the bowling, but he declines. The home side loses two quick wickets, but their captain joins one of the openers, and stops the rot. Both batsmen gain in confidence, and begin to score freely. At 65 the remaining opening bat skies a ball nearly for six, but is spectacularly caught in the deep by the horse, running from mid-off round to deep extra cover. His successor however settles in rapidly, and soon the score is 100 for three. The visiting captain again presses the horse to bowl, but he again refuses, politely but firmly. The innings continues. At 122 the captain is tempted by a third run, as the horse appears to have misfielded his off-drive, but the horse throws in like lightning, throwing down the bowler's wicket. Unfortunately, the new man in settles down rapidly, and the score is soon mounting again. At 155 the visiting captain is becoming desperate. He again approaches the horse, asking him to take an over. The horse refuses, with every sign of embarrassment. Eighteen runs are scored off the next two overs. At 173 for 4, defeat for the visitors seems inevitable. The captain approaches the horse: “Please take this over! If you won't, at least tell me why not!” The horse shamefacedly replies: “I can't possibly! Did you ever hear of a horse who could bowl?”

This and similar jokes are prior art (see for example Shakespeare/Fletcher, “The Two Noble Kinsmen”, 1614, tennis-playing horse). According to the present invention, it is improved by employing alliteration in the punch line. Thus the horse may be transposed to a bull: “Did you ever hear of a bull who could bowl?” A bear is another large mammal that can be effectively substituted. It is also within the skill of the art to adapt the joke to other sports, for example, baseball: “ . . . a puma who could pitch?” (a panther is equally effective); or tennis “ . . . a vulture who could volley?”; and so on. For the alliterative letters, plosives are preferred.

This joke is impractical to rehearse.

### EXAMPLE 2

The invention in its second aspect is practised as follows. A UK patent application for an invention accompanied by a specification describing the joke of Example 1 (among others) was filed in the UK Patent Office on 30 Aug. 2003, being allotted the official reference GB0320419.5. The invention is the joke as set forth in Example 1, and was characterised by claims defining it as a joke in which the humour derives from accounts of exceptional but partial skill of animals (preferably large mammals or birds) in sports involving spheroidal projectiles, in which the punch-line relies on alliteration. The patent application is maintained. Search and examination are requested. The patent application is allowed to publish. Before the end of the Convention year a PCT application to protect the invention is filed, claiming priority from the UK patent application, and designating all countries for the time being members of the PCT. The PCT application is maintained pending as long as possible, and then prosecuted to grant or final rejection in a selection of designated countries.

### EXAMPLE 3

This is an example of a practical joke with a specific commercial use. It is adapted to be either recited or rehearsed. The following description (a recital of the joke) describes how it can be rehearsed.

London Transport's underground railway system (‘tube’, Metro) gives notice to passengers on its escalators: “Dogs must be carried”. However, the vast majority of passengers are not accompanied by dogs. The present joke consists in supplying this deficit. At least two operators are needed. They station themselves one at each end of an escalator, as close as possible to the relevant sign. Each displays his or her own sign, saying “Get your dog here! Dogs for hire—Only 50p a dog!” “All profits to Cancer Relief”. Passengers who are willing to contribute pay their 50p, collect a dog from the first operative, pass down (or up) the escalator, return the dog to the second operative, and depart. Each operative must be ready to explain to passengers how the scheme works, and why it is appropriate for them to hire a dog. It is preferred not to use live dogs, as they are more expensive, require careful handling, and passengers may sometimes be unwilling to return them. Toy dogs (toys in the form of dogs, not toy breeds of dog) are therefore preferred. The invention further comprises a kit of parts for rehearsing this joke, including at least one (preferably at least two) display placards for motivating passengers to hire dogs, at least one set of instructions explaining to operators how to rehearse the joke, a plurality of dogs, and at least one (preferably at least two) retaining means for retaining dogs prior to or after hiring. If live dogs are used, each is preferably provided with a leash, and the retaining means may comprise a massive body with anchoring means (such as a post, rail or ring) to which leashes may be demountably attached. For toy dogs, the retaining means may be a container, for example a plastic bin or bag. Collecting boxes are a further optional feature of the kit.

### EXAMPLE 4

The invention in its other aspect is practised as follows: A UK patent application for the invention, accompanied by a specification describing (inter alia) the joke of Example 3, was filed in the UK Patent Office on 30 Aug. 2003. The invention is the joke as set forth in Example 3. The joke was characterised by claims defining it as follows: “In a locus in which the behaviour of the public is subject to a promulgated rule intended to be conditional, the joke which comprises misinterpreting the rule as absolute, and providing means for enabling the public to conform to the rule so misinterpreted.” Subclaims specified that the locus is a public transport system, that the means is provided against consideration, and that at least part of that consideration is stated to be devoted to charitable causes. Further actions to protect the joke are taken as described in Example 1 above.

### EXAMPLE 5

This example relates to a practical joke that is self-referential, and may have commercial applications. It consists in the filing of a patent application to protect the method of protecting jokes by filing one or more patent applications thereon. The invention so defined is protected by filing and prosecuting the patent application referred to in Examples 2 and 4, and one or more other applications claiming priority therefrom. The joke may be either recited or rehearsed, though repeated rehearsal may be pointless once the joke becomes public knowledge, unless the priority of the initial rehearsal can be claimed.

### EXAMPLE 6

A patent application describing and claiming the jokes set out herein in Examples 1-7 was filed at the UK Patent Office on 1 Apr. 2004.

### EXAMPLE 7

Russell (Principles of Mathematics, 1903) divides sets into two classes: sets which are members of themselves (for example, the set of all sets) and those which are not (for example, the set of all positive integers). Following Russell, we may divide patent applications into two classes: patent applications which claim themselves, and those which do not. We term the former ‘homoproprietary’ and the latter ‘heteroproprietary’. Until now, no patent applications have claimed themselves: or to put it another way, the set of homoproprietary patent applications has been the null set. However, the present application and its predecessors GB0320419.5 and GB0407439.9 claim themselves. Accordingly the present invention includes the novel concept of homoproprietary patent applications, and provides working examples thereof. This is a novel product, or concept, which will have general utility. In any patent application it will be possible to include claims to the application itself, generically defined. These may prove useful in controlling the activities of competitors in the same technical area, by preventing them from filing patents of improvement or dependency, for example. Objections of non-unity (or in some jurisdictions, different areas of search) may require such applications to be amended, restricted or divided prior to grant. Such amended applications, and divisionals, also form aspects of the invention. Such applications may, by amendment, become heteroproprietary, but remain within the scope of the invention so long as they claim priority from a homoproprietary patent application. Preferred patent applications according to this aspect of the invention are regional applications, e.g. PCT applications and European patent applications: and applications filed in countries sympathetic to ‘business method patents’, including USA, Japan and Australia.

Note that the concept of a homoproprietary patent application is intrinsically comic (so Example 7 is an example of a joke that may be protected by the process of claim 1), but further specific applications of the concept are not necessarily funny.

I claim:

1. The process of protecting a novel joke which comprises filing a patent application defining the novel features of the joke.

2. The process claimed in claim 1 in which the patent application is subsequently maintained.

3. The process as claimed in claim 2 in which the patent application is prosecuted at least to official publication.

4. The process as claimed in either of claims 2 or 3 in which the patent application is prosecuted to grant or refusal.

5. A process claimed in any of claims 1 to 4 in which the joke is an adaptation or improvement of a known joke.

6. A process as claimed in any of claims 1-5 in which the joke is an anecdote, a pun, a wisecrack, irony, a ‘shaggy dog story’, or a cartoon.

7. A process as claimed in any of claims 1-6 in which the joke is self-referential.

8. A joke protected by a process claimed in any of claims 1-7.

9. A patent application or patent claiming a joke as claimed in claim 8.

10. A joke relating to the unexpected but partial skill of animals (preferably large mammals or birds) in sports involving spheroidal projectiles, characterised in that the punch-line employs alliteration.

11. A joke as claimed in claim 10 in which the punch line takes the form: “Whoever heard of a (large animal beginning with plosive consonant x) who could (perform sporting action beginning with plosive consonant x)!”

12. In a locus in which the behaviour of the public is subject to a promulgated rule intended to be conditional, the joke which comprises misinterpreting the rule as absolute, and providing means for enabling the public to conform to the rule so misinterpreted.

13. The joke claimed in claim 12 in which the locus is a public transport system.

14. A joke claimed in either of claims 12 or 13 in which the enabling means is provided against consideration.

15. A joke claimed in claim 14 wherein at least part of the consideration is stated to be devoted to charitable causes.

16. A joke as claimed in any of claims 12 to 15 in which the enabling means are dogs.

17. The joke which comprises the filing of a patent application to protect the method of protecting jokes by filing one or more patent applications thereon.

18. The process of reciting a joke claimed in any of claims 8 and 10-17.

19. The process of rehearsing a joke claimed in any of claims 8 and 12-17.

20. A joke claimed in any of claims 8 and 11-17 recorded on a medium, e.g. paper or videotape.

21. A joke as claimed in claim 18 in which the medium is computer-readable, for example a hard disk, floppy, CD or DVD.

22. A process claimed in any of claims 1-7 in which the patent application is filed, or claims priority from an application that is filed, on 1 April,

23. A homoproprietary patent application or patent.

24. An application claiming priority from a patent application claimed in claim 23, or a patent granted on such an application

25. A kit of parts for carrying out the joke claimed in any of claims 12-16.
